(19) United States
(12) Patent Application Publication
(10) Pub. No.: US 2018/0054345 A1
(43) Pub. Date: Feb. 22, 2018

(54) TRANSMISSION APPARATUS AND TRANSMISSION METHOD, RECEPTION APPARATUS AND RECEPTION METHOD, TRANSMISSION SYSTEM, AND PROGRAM

(71) Applicant: Sony Corporation, Tokyo (JP)

(72) Inventor: Takashi Yokokawa, Kanagawa (JP)

(21) Appl. No.: 15/554,370

(22) PCT Filed: Mar. 10, 2016
(86) PCT No.: PCT/JP2016/057544

§ 371 Date: Aug. 29, 2017

(30) Foreign Application Priority Data
Mar. 24, 2015 (JP) 2015-060805

(51) Int. Cl. H04L 29/04; G06F 1/32

(52) U.S. Cl. CPC H04L 29/04; H04N 21/436; G06F 1/3237; G06F 1/3265

(57) ABSTRACT

The present technology relates to a transmission apparatus and a transmission method, a reception apparatus and a reception method, a transmission system, and a program by which a bandwidth is efficiently used such that power saving can be realized even if transmission of any stream is stopped in transmitting and receiving a plurality of streams formed of visible image data in accordance with a standard in DisplayPort (trademark).

In transmitting a plurality of streams, lanes for processing on a stream-by-stream basis are allocated in each of a transmitter and a receiver. With this, even if transmission of any stream is stopped, processing of a corresponding lane can be stopped. Therefore, it is possible to efficiently stop a bandwidth such that power saving can be realized. The present technology is applicable to a display port.

### TECHNICAL FIELD

The present technology relates to a transmission apparatus and a transmission method, a reception apparatus and a reception method, a transmission system, and a program and particularly to a transmission apparatus and a transmission method, a reception apparatus and a reception method, a transmission system, and a program that efficiently use a transmission bandwidth such that power saving can be realized.

### BACKGROUND ART

A standard of an interface that transmits image data to a display, which is called DisplayPort (trademark), is commonly used (e.g., see Non-Patent Literature 1).

### CITATION LIST

### Non-Patent Literature

Non-Patent Literature 1: DisplayPort (trademark) Version1.2a VESA (Video Electronics Standards Association)

### DISCLOSURE OF INVENTION

### Technical Problem

By the way, in the DisplayPort (trademark) standard, a transmission scheme called Virtual Channel is defined. In the transmission scheme, a plurality of streams are transmitted through a single transmission channel to a plurality of streams sinks from a plurality of stream sources.

In the Virtual Channel, the plurality of streams are subjected to time division processing and transmitted by a stream transmission processing unit and a stream reception processing unit each of which processes a plurality of streams. At this time, respective processing timings are allocated as divided time slots. In addition, the stream transmission processing unit and the stream reception processing unit each transmit allocated streams through processing in four lanes at the respective processing timings. That is, in the Virtual Channel, a plurality of stream transmission processing units and a plurality of stream reception processing units each perform processing in four lanes at predetermined time-divided processing timings. In this manner, a plurality of streams are transmitted.

With such a configuration, in the Virtual Channel of the DisplayPort (trademark) standard, for example, if transmission of any stream of the plurality of streams is stopped, the stream transmission processing unit and the stream reception processing unit that process the stream whose transmission is stopped do not work at a timing for processing the stream whose transmission is stopped out of the allocated time slots since the time slot is also allocated to the stream whose transmission is stopped. However, since the bandwidth should be ensured, the stream transmission processing unit and the stream reception processing unit that process the stream whose transmission is stopped cannot be completely stopped and electric power continues to be consumed.

The present technology has been made in view of the above-mentioned circumstances particularly to efficiently use a bandwidth such that power saving can be realized even if transmission of any of a plurality of transmitted streams is stopped.

### Solution to Problem

A transmission apparatus according to a first aspect of the present technology is a transmission apparatus that transmits visible image data formed of effective pixel data of an image pickup apparatus by using a format for transmitting to a display, the transmission apparatus including: a transmitter that transmits a plurality of streams formed of the visible image data to respective stream sinks from respective stream sources through a plurality of lanes in a single transmission channel; and a controller that assigns the plurality of streams to the plurality of lanes on a stream-by-stream basis, in which the transmitter transmits the plurality of streams through the lanes assigned by the controller on the stream-by-stream basis.

The format for transmitting to the display can be a format defined by DisplayPort (trademark), and the transmitter can use a Virtual Channel defined by the DisplayPort (trademark) to transmit the plurality of streams formed of the visible image data to the respective stream sinks from the respective stream sources through the plurality of lanes in the single transmission channel.

If transmission of any stream of the plurality of streams is stopped, the controller can output, via the transmission channel, a stop signal for notifying that transmission through a corresponding lane is stopped.

The stop signal can be a signal in starting an ALPM (Advanced Link Power Management) state defined by DisplayPort (trademark).

The transmission apparatus can further include an auxiliary communication unit different from the transmission channel that communicates with a reception apparatus that receives the plurality of streams, in which if transmission of any stream of the plurality of streams is restarted, the controller can notify the reception apparatus of a restart signal via the auxiliary communication unit, the restart signal indicating that transmission through a corresponding lane is restarted.

The restart signal can be a signal in terminating an ALPM (Advanced Link Power Management) state defined by DisplayPort (trademark).

The transmission apparatus can further include an auxiliary communication unit different from the transmission channel that communicates with a reception apparatus that receives the plurality of streams, in which the controller can use the auxiliary communication unit to notify a reception apparatus that receives the plurality of streams of information indicating that the plurality of streams are assigned to the plurality of lanes on the stream-by-stream basis.

A transmission method according to the first aspect of the present technology is a transmission method for a transmission apparatus that transmits visible image data formed of effective pixel data of an image pickup apparatus by using a format for transmitting to a display, the transmission method including: a transmission step of transmitting a plurality of streams formed of the visible image data to respective stream sinks from respective stream sources through a plurality of lanes in a single transmission channel; and a control step of assigning the plurality of streams to the plurality of lanes on a stream-by-stream basis, in which processing of the transmission step transmits the plurality of streams through the lanes assigned by processing of the control step on the stream-by-stream basis.

A program according to the first aspect of the present technology is a program that causes a computer that controls a transmission apparatus that transmits visible image data formed of effective pixel data of an image pickup apparatus by using a format for transmitting to a display to execute processing including: a transmission step of transmitting a plurality of streams formed of the visible image data to respective stream sinks from respective stream sources through a plurality of lanes in a single transmission channel; and a control step of assigning the plurality of streams to the plurality of lanes on a stream-by-stream basis, in which the processing of the transmission step transmits the plurality of streams through the lanes assigned by the processing of the control step on the stream-by-stream basis.

A reception apparatus according to a second aspect of the present technology is a reception apparatus that receives visible image data formed of effective pixel data of an image pickup apparatus by using a format for transmitting to a display, the reception apparatus including: a receiver that receives a plurality of streams formed of the visible image data, which are transmitted to the respective stream sinks from the respective stream sources, through the plurality of lanes in the single transmission channel; and a controller that assigns the plurality of streams to the plurality of lanes on a stream-by-stream basis, in which the receiver receives the plurality of streams in the lanes assigned by the controller on the stream-by-stream basis.

The format for transmitting to the display can be a format defined by DisplayPort (trademark), and the receiver can use a Virtual Channel defined by the DisplayPort (trademark) to receive the plurality of streams formed of the visible image data to the respective stream sinks from the respective stream sources through the plurality of lanes in the single transmission channel.

The reception apparatus can further include an auxiliary communication unit different from the transmission channel that communicates with a transmission apparatus that transmits the plurality of streams, in which the controller can use the auxiliary communication unit to receive information indicating that the plurality of streams are assigned to the plurality of lanes on the stream-by-stream basis from the transmission apparatus that transmits the plurality of streams and to assign, on the basis of the received information, the plurality of streams to the plurality of lanes on the stream-by-stream basis.

A reception method according to the second aspect of the present technology is a reception method for a reception apparatus that receives visible image data formed of effective pixel data of an image pickup apparatus by using a format for transmitting to a display, the reception method including: a reception step of receiving a plurality of streams formed of the visible image data, which are transmitted to respective stream sinks from respective stream sources through a plurality of lanes in a single transmission channel; and a control step of assigning the plurality of streams to the plurality of lanes on a stream-by-stream.

basis, in which processing of the reception step receives the plurality of streams in the lanes assigned by processing of the control step on the stream-by-stream basis.

A program according to the second aspect of the present technology is a program that causes a computer that controls a reception apparatus that receives visible image data formed of effective pixel data of an image pickup apparatus by using a format for transmitting to a display to execute processing including: a reception step of receiving a plurality of streams formed of the visible image data, which are transmitted to respective stream sinks from respective stream sources through a plurality of lanes in a single transmission channel; and a control step of assigning the plurality of streams to the plurality of lanes on a stream-by-stream basis, in which the processing of the reception step receives the plurality of streams in the lanes assigned by the processing of the control step on the stream-by-stream basis.

A communication system according to a third aspect of the present technology is a transmission system including: a transmission apparatus that transmits visible image data formed of effective pixel data of an image pickup apparatus by using a format for transmitting to a display; and a reception apparatus, in which the transmission apparatus includes a transmitter that transmits a plurality of streams formed of the visible image data to respective stream sinks from respective stream sources through a plurality of lanes in a single transmission channel, and a first controller that assigns the plurality of streams to the plurality of lanes on a stream-by-stream basis, the transmitter transmits the plurality of streams through the lanes assigned by the first controller on the stream-by-stream basis, the reception. apparatus includes a receiver that receives a plurality of streams formed of the visible image data, which are transmitted to the respective stream sinks from the respective stream sources, through the plurality of lanes in the single transmission channel; and a second controller that assigns the plurality of streams to the plurality of lanes on the stream-by-stream basis, and the receiver receives the plurality of streams in the lanes assigned by the second controller on the stream-by-stream basis.

In the first aspect of the present technology, a plurality of streams formed of the visible image data to respective stream sinks are transmitted from respective stream sources through a plurality of lanes in a single transmission channel. The plurality of streams are assigned to the plurality of lanes on a stream-by-stream basis. The plurality of streams are transmitted through the lanes assigned on the stream-by-stream basis.

In the second aspect of the present technology, a plurality of streams formed of the visible image data, which are transmitted to the respective stream sinks from the respective stream sources, are received through the plurality of lanes in the single transmission channel. The plurality of streams are assigned to the plurality of lanes on a stream-by-stream basis. The plurality of streams are received in the lanes assigned on the stream-by-stream basis.

In the third aspect of the present technology, by the transmission apparatus, a plurality of streams formed of the visible image data are transmitted to respective stream sinks from respective stream sources through a plurality of lanes in a single transmission channel, the plurality of streams are assigned to the plurality of lanes on a stream-by-stream basis, and the plurality of streams are transmitted through the lanes assigned on the stream-by-stream basis. By the reception apparatus, a plurality of streams formed of the visible image data, which are transmitted to the respective stream sinks from the respective stream sources, are received through the plurality of lanes in the single transmission channel, the plurality of streams are assigned to the plurality of lanes on a stream-by-stream basis, and the plurality of streams are received in the lanes assigned on the stream-by-stream basis.

The transmission apparatus and the reception apparatus that constitute the transmission apparatus according to the first aspect of the present technology, the reception apparatus according to the second aspect, and the transmission system according to the third aspect may be independent apparatuses or may be blocks that performs transmission processing.

### Advantageous Effects of Invention

In accordance with the aspects of the present technology, it becomes possible to efficiently use a bandwidth such that power saving can be realized even if transmission of any of a plurality of transmitted streams is stopped.

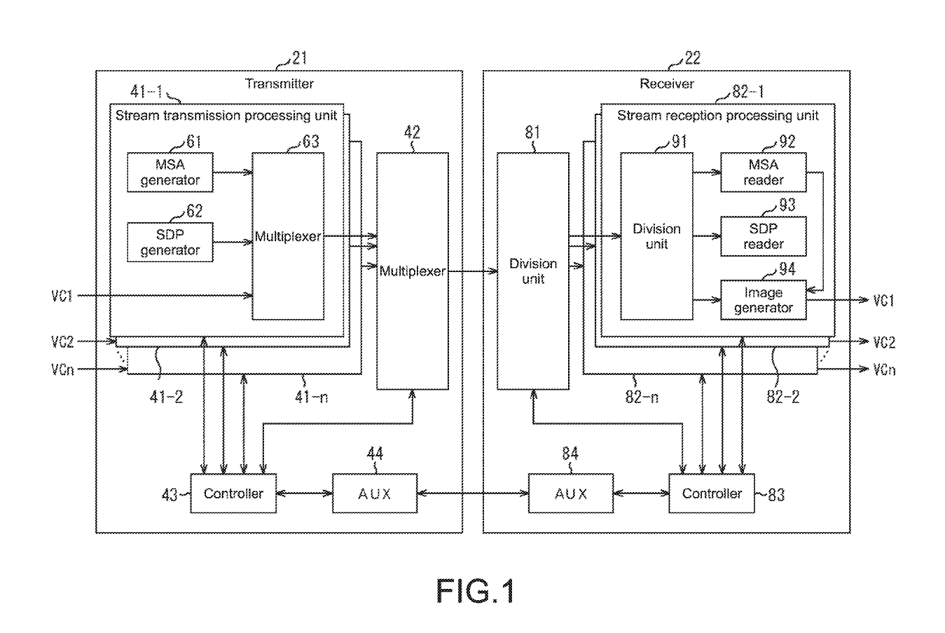

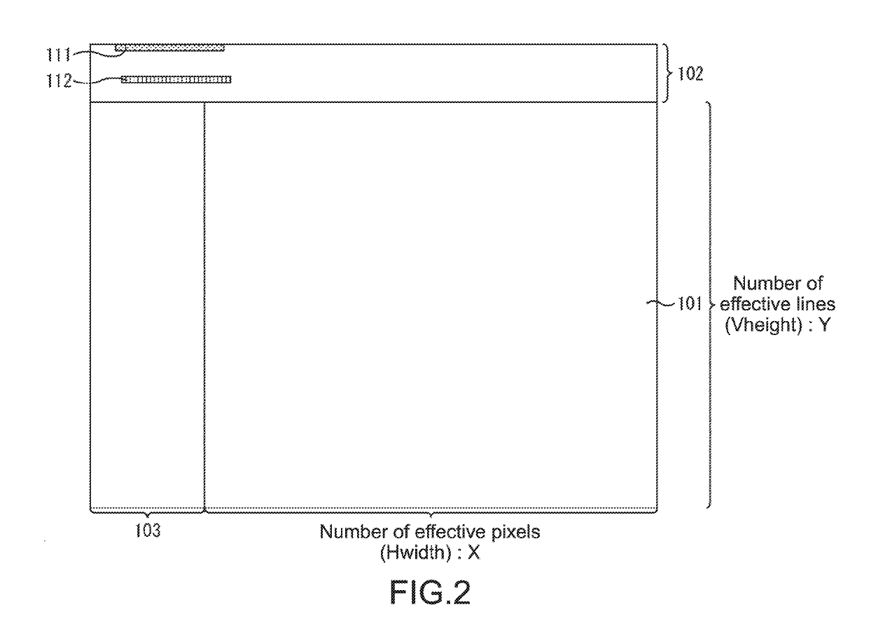

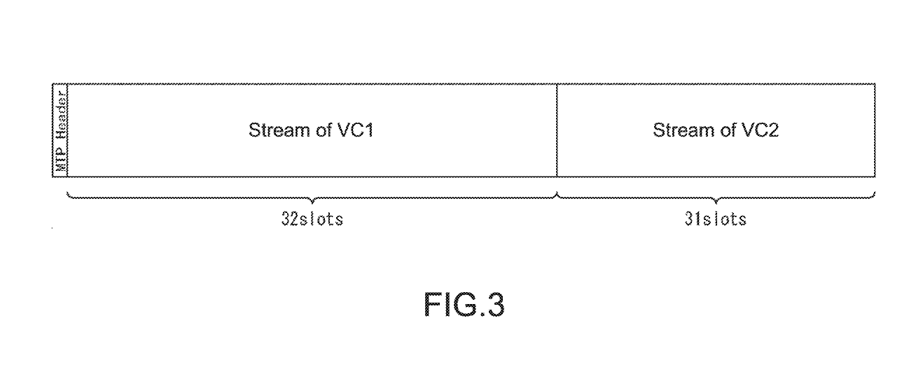

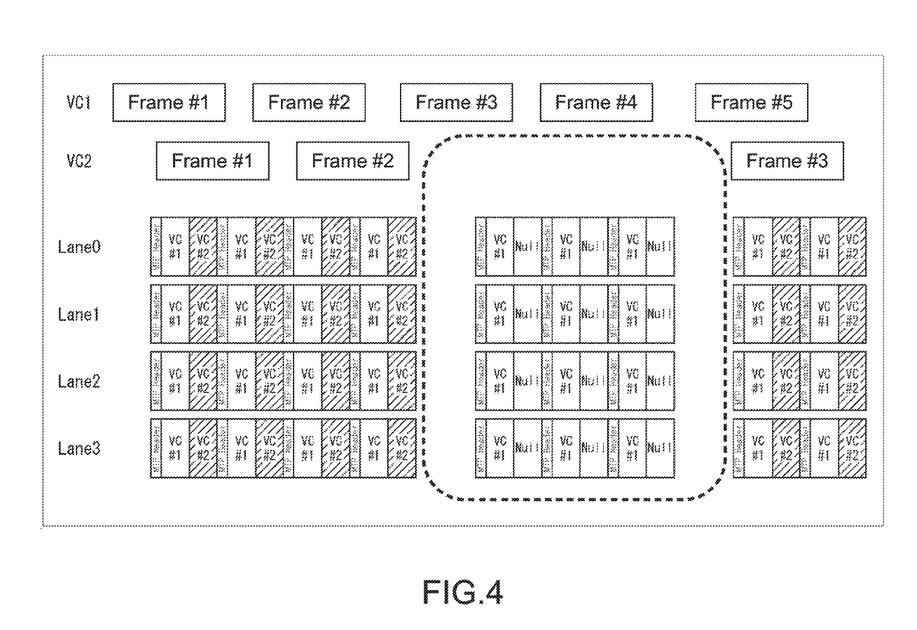

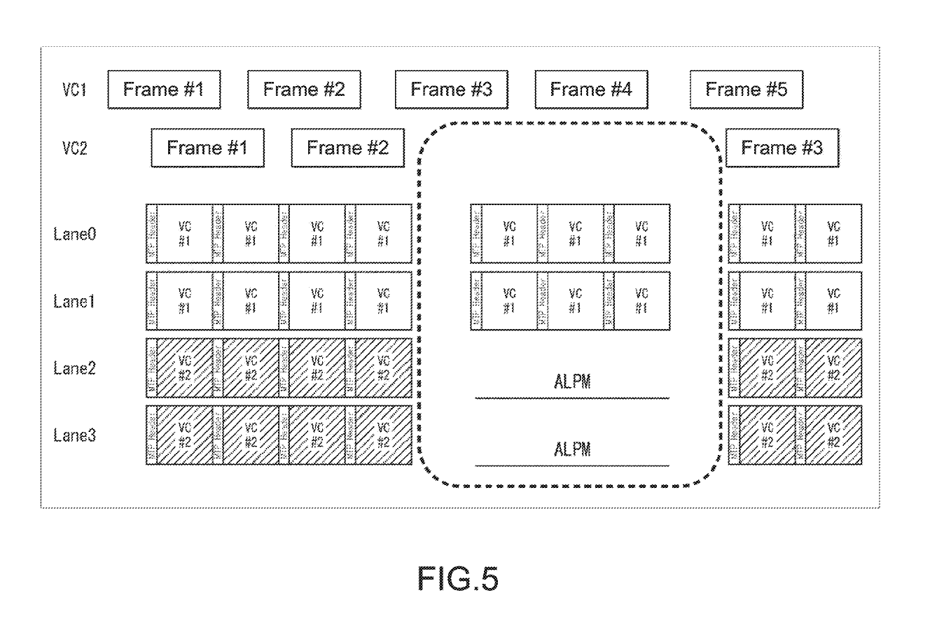

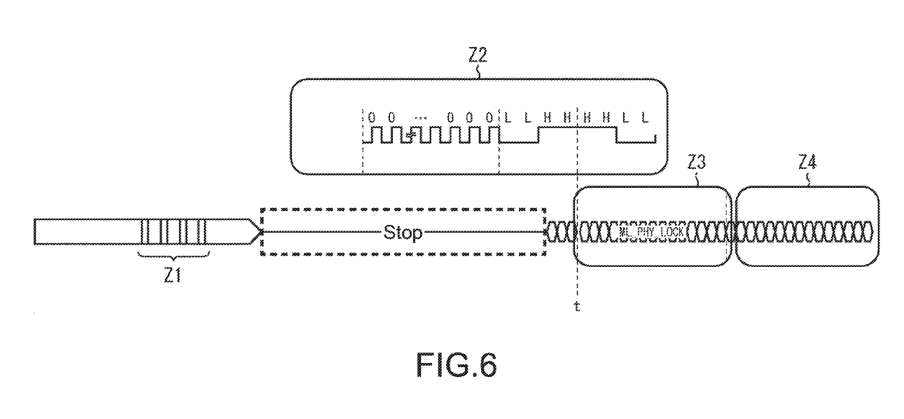

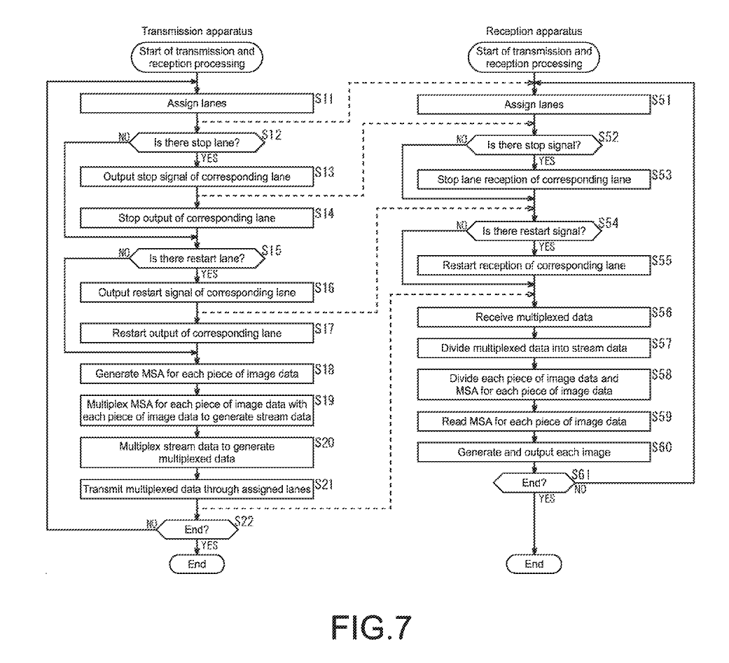

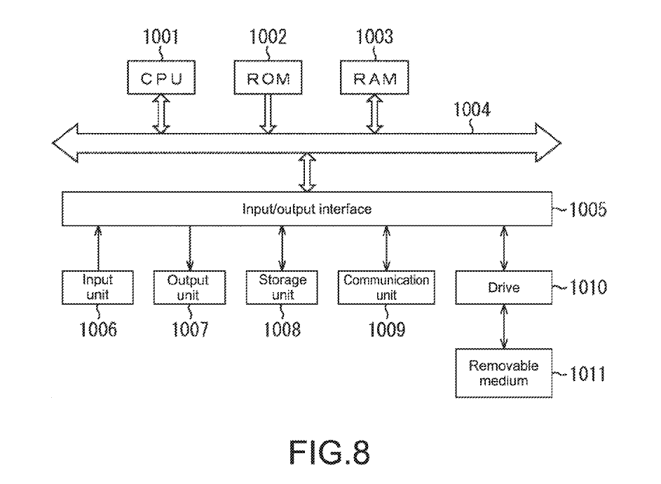

### BRIEF DESCRIPTION OF DRAWINGS

[FIG. 1] A diagram showing a configuration example of an embodiment of a transmission system to which the present technology is applied.

[FIG. 2] A diagram describing MSA and SDP.

[FIG. 3] A diagram describing a Virtual Channel.

[FIG. 4] A diagram describing a general transmission scheme.

[FIG. 5] A diagram describing a transmission scheme to which the present technology is applied.

[FIG. 6] A diagram describing a stop signal in stopping transmission and a restart signal in restarting.

[FIG. 7] A flowchart describing transmission and reception processing by the transmission system of FIG. 1.

[FIG. 8] A diagram describing a configuration example of a general-purpose personal computer.

### MODE(S) FOR CARRYING OUT THE INVENTION

<Configuration Example of Transmission System Using Virtual Channel>

FIG. 1 shows a configuration example of an embodiment of a transmission system to which the present technology is applied. The transmission system of FIG. 1 is a system that transmits image data generated (captured) by an image pickup apparatus (not shown).

More specifically, the transmission system of FIG. 1 is constituted by a transmitter 21 and a receiver 22. The transmitter 21 transmits, to the receiver 22, visible image data supplied by the image pickup apparatus (not shown) by using a format called Virtual Channel of DisplayPort (trademark) that is a standard for transmitting to a display. The receiver 22 receives visible image data transmitted from the transmitter 21. Note that, in the present specification, it is assumed that an image is constituted by a plurality of pixels and image data is constituted by pixel data that is data on pixel values and the like of a plurality of pixels.

Next, configurations of the transmitter 21 and the receiver 22 in the transmission system of FIG. 1 will be described.

The transmitter 21 includes stream transmission processing units 41-1 to 41-n, a multiplexer 42, a controller 43, and an AUX (auxiliary communication unit) 44. Further, each of the stream transmission processing units 41-1 to 41-n includes an MSA generator 61, an SDP generator 62, and a multiplexer 63 and generates stream data formed of visible image data and outputs it to the multiplexer 42. Note that, if the stream transmission processing units 41-1 to 41-n do not have to be distinguished from one another, they will be simply referred to as stream transmission processing units 41 and other configurations will be also referred in a similar way.

The multiplexer 42 transmits, to the receiver 22, multiplexed data obtained by time division multiplexing the stream data formed of the visible image data supplied from a plurality of stream transmission processing units 41-1 to 41-n.

The controller 43 comprehensively controls operations of the transmitter 21. Further, when starting transmission of streams, the controller 43 assigns lanes on a stream-by-stream basis and instructs ail the stream transmission processing units 41 and notifies the receiver 22 by using the AUX (auxiliary communication unit) 44. In addition, when stopping transmission of any of a plurality of transmitted streams to the receiver 22, the controller 43 causes the multiplexer 42 to output a stop signal to the receiver 22 with the stop signal being included in multiplexed data. Further, when restarting transmission of streams whose transmission is stopped, the controller 43 notifies the receiver 22 of restart information by using the AUX (auxiliary communication unit) 44.

The MSA generator 61 generates MSA (Main Stream Attributes) that are image property information such as the number of lines per frame, the number of pixels per line, the number of bits per pixel, and the like of image data (visible image data) formed of effective pixel data, which is to be transmitted, and supplies them to the multiplexer 63.

On the basis of additional data such as audio data, the SDP generator 62 generates packets, which are called SDP (Secondary-Data Packets), according to a format for packetizing and transmitting in a horizontal blanking region and a vertical blanking region other than an effective pixel region and supplies them to the multiplexer 63.

The multiplexer 63 multiplexes MSA supplied from the NSA generator 61, SDP supplied from the SDP generator 62, and image data (visible image data) formed of input effective pixel data and outputs them as multiplexed data.

The receiver 22 includes a division unit 81, stream reception processing units 82-1 to 82-n, a controller 83, and an AUX (auxiliary communication unit) 84.

The division unit 81 divides multiplexed data transmitted from the transmitter 21, a plurality of pieces of stream data formed of a plurality of pieces of visible image data and supplies them to the stream reception processing units 82-1 to 82-n.

Each of the stream reception processing units 82 includes a division unit 91, an MSA reader 92, an SDP reader 93, and an image generator 94. The stream reception processing unit 82 generates and outputs visible image data from stream data of the pieces of stream data formed of the plurality of pieces of visible image data, which is allocated.

The division unit 91 divides multiplexed data for each of streams supplied from the division unit 81 into MSA, SDP, and visible image data and supplies the MSA to the MSA reader 92, the SDP to the SDP reader 93, and the visible image data to the image generator 94.

The MSA reader 92 reads, on the basis of the supplied MSA, the information on the number of lines per frame, the number of pixels per line, and the number of bits per pixel of the visible image data and supplies the read information to the image generator 94.

The SDP reader 93 reads the SDP and extracts and outputs packetized additional data.

The image generator 94 acquires visible image data and reconfigures and outputs the visible image on the basis of the information on the MSA.

The controller 83 comprehensively controls operations of the receiver 22. Further, when starting transmission of streams, the controller 83 uses the AUX (auxiliary communication unit) 84 to receive information indicating that lanes have been assigned on the stream-by-stream basis, which is notified by the transmitter 21, and notifies all the stream reception processing units 82 of that fact. In addition, the controller 83 receives the stop signal included in the multiplexed data, which indicates that transmission of any of a plurality of streams transmitted from the transmitter 21 via the division unit 81 is to be stopped, and instructs all the stream reception processing units 82 of corresponding processing. Further, the controller 83 receives, via the AUX (auxiliary communication unit) 84, information indicating that transmission of any is to be restarted for example and instructs the division unit 81 and the stream reception processing unit 82 to perform corresponding processing.

<Regarding MSA (Main Stream Attributes) and SDP (Secondary-Data Packet)>

Next, a structure of the image data and the NSA and SDP will be described with reference to FIG. 2.

The NSA is for using the vertical blanking region for each frame to packetize and transmit image property information of the stream. Further, the SDP is for using the horizontal blanking region and the vertical blanking region for each frame to packetize and transmit data other than the visible image data (effective pixel data).

Regarding the structure of the image data, as shown in FIG. 2, a lower right region ((number of effective pixels (Hwidth): X)×(number of effective lines (Vheight): Y)) is an the effective pixel region 71.

Above the effective pixel region 71, provided is a vertical blanking region (Vblank) 72 in which MSA 111 and SDP 112 are arranged.

Further, a horizontal blanking region (Hblank) 73 is provided on a left-hand side of the effective pixel region 71.

<Regarding Virtual Channel>

Next, a transmission scheme using the Virtual Channel defined by the DisplayPort (trademark) will be described. The Virtual Channel is a scheme for transmitting a plurality of streams through a single transmission channel to a plurality of streams sinks from a plurality of stream sources. The transmission system of FIG. 1 transmits a plurality of streams formed of visible image data that is a plurality of stream sources by using the Virtual Channel.

With the Virtual Channel, the time slot can be divided into 63 segments in accordance with requirements of DisplayPort (trademark). Therefore, for example, if streams formed of visible image data that are streams VC1 and VC2 having identical image quality are transmitted, 32 time slots (slots) are allocated to the stream VC1 while 31 time slots are allocated to the stream VC2 as shown in FIG. 3 when time division multiplexing is performed at an approximately identical ratio. Note that one top slot is allocated to a header (MTP Header).

That is, by using the Virtual Channel, time division multiplexing and transmission are performed, and hence two streams are transmitted to two stream sinks (stream sinks of two visible images) from two stream sources (stream sources of two visible images) through one transmission channel. As a result, it becomes possible to transmit the visible image data of the two streams.

Note that, in FIG. 3, division into at most 63 slots is defined. Therefore, the number of streams that can be transmitted and received is at most 63.

<Regarding General Transmission Method>

In accordance with requirements of DisplayPort (trademark), the stream transmission processing units 41-1 to 41-n of the transmitter 21 and the stream reception processing units 82-1 to 82-n of the receiver 22 each perform transmission processing through processing through four lanes. Therefore, in a case where the two streams of the streams VC1 and VC2 are transmitted as shown in the upper part of FIG. 4, the stream transmission processing unit 41 and the stream reception processing unit 82 each execute processing on the basis of time slots as shown in the lower part of FIG. 4. That is, following one slot that is the header in each of Lane0 to Lane4, the stream VC1 in an amount corresponding to 32 slots is processed and the stream VC2 in an amount corresponding to the remaining 31 slots is processed.

As a result, at a timing departing from a range surrounded with the dotted lines of FIG. 4, the processing is efficiently performed. Note that, in the upper section of FIG. 4, frames #1 to #5 that constitute the stream VC1 and frames #1 to #3 that constitute the stream VC2 are chronologically transmitted. Further, in the lower section, signals transmitted in each of Lane0 to Lane4 are shown. In the figures, MPT Header indicates a header, VC#1 indicates a timing for processing of transmitting each of frame images of the stream VC1, and VC#2 indicates a timing for processing of transmitting each of frame images of the stream VC2.

However, if transmission of the stream VC2 is stopped in the middle as in the range surrounded with the dotted line, that in an amount corresponding to the late 31 slots of the time slots that are 64 slots at that timing is not processed. Note that, in the figure, they are expressed as Null. That is, despite the absence of data that should be transmitted, there is a need for ensuring a bandwidth and unnecessary power consumption continues. That is, in the transmission scheme using the Virtual Channel defined by DisplayPort (trademark), there is a fear that unnecessary power consumption may continue if transmission of some streams is stopped.

<Regarding Transmission Method to which Present Technology is Applied>

In view of this, in the transmission system of FIG. 1 to which the present technology is applied, lanes are assigned for each stream and the stream whose transmission is stopped is brought into a halt state for each lane. At this time, for stopping and restarting transmission for each lane, ALPM (Advanced Link Power Management) that is a function of stopping stream transmission defined by DisplayPort (trademark) is used.

That is, for example, as shown in FIG. 5, Lane0 and Lane1 are assigned with respect to the stream VC1 and Lane2 and Lane3 are assigned with respect to the stream VC2. By doing so, as in the range surrounded with the dotted line of FIG. 5, also if transmission of the stream VC2 is stopped, it is only necessary to stop transmission in Lane2 and Lane3. Therefore, it becomes possible to reduce power consumption corresponding to that amount. Note that, in the figure, the stop state is expressed as ALPM.

ALPM is a function of performing instructions of the stop and restart for each lane. For example, if input of any stream is stopped, the controller 43 of the transmitter 21 causes the multiplexer 42 to output, as shown in a range Z1 of FIG. 6, information on a lane to be stopped as well as stop information indicating that transmission is to be stopped with they being included in multiplexed data. Correspondingly, the stop information obtained by the division unit 81 of the receiver 22 dividing the multiplexed data is supplied to the controller 83. On the basis of this stop information, the controller 83 supplies information regarding which lane is to be stopped to the stream reception processing unit 82. At a timing described as “Stop” surrounded with the dotted line in the figure, the controller 63 performs control to stop processing through a corresponding lane.

Further, if the input of any stream is restarted, the controller 43 of the transmitter 21 supplies a restart signal indicating the restart of transmission as shown in a range Z2 of FIG. 7, to the receiver 22 via the AUX 44. Note that FIG. 7 describes a stop signal for starting the ALPM state and a restart signal for terminating the ALPM state. The upper section of the figure shows transmission of the restart signal in communication by the AUXs 44 and 84. The lower section or the figure shows a stop signal multiplexed on the multiplexed data between the multiplexer 42 and the division unit 81 and transmitted and multiplexed data when transmission is restarted.

In addition, when receiving a restart signal from the AUX 84, the controller 83 of the receiver 22 supplies the stream reception processing unit 82 with information on a lane in which reception is restarted and restart information. In addition, at a point of time t that is a timing at which a predetermined time has elapsed after the restart signal is transmitted, the multiplexer 42 generates a training pattern as shown by a range Z3 and supplies it to a corresponding lane. After that, the multiplexer 42 continuously restarts transmission of the stream successively from a vertical blanking signal that is the top of data of each frame as shown by a range Z4.

Correspondingly, the controller 83 of the receiver 22 controls the stream reception processing unit 82 to receive the training pattern as shown by the range Z3 from Lane in which transmission had been stopped and further to restart reception of the streams successively from the vertical blanking signal shown by the range Z4.

In the above-mentioned manner, for the four-lane processing on the plurality of streams defined by DisplayPort (trademark), the lanes are assigned for each stream and the ALPM (Advanced Link Power Management) that is the function of stopping transmission on a lane-by-lane basis is further used. Thus, it becomes possible to achieve power saving by stopping the operation on the lane-by-lane basis even if transmission of any stream is stopped, for example.

<Transmission and Reception Processing>.

Next, transmission and reception processing in transmitting the two streams VC1 and VC2 formed of the visible image data in the transmission system of FIG. 1 will be described with reference to the flowchart of FIG. 7. Note that it is assumed that no additional data is transmitted here.

In Step S11, the controller 43 assigns streams that should be transmitted to Lane0 to Lane3 in each stream transmission processing unit 41 and notifies all the stream transmission processing units 41 of it. Further, the controller 43 supplies information indicating that Lane0 to Lane3 are assigned to the receiver 22 via the AUX 44.

In Step S12, the controller 43 determines whether or not a lane that, stops transmission of any stream has been generated by transmission of any being stopped. For example, if transmission of any streams is not stopped, the processing of Steps S13 and S14 is skipped and the processing proceeds to Step S15.

In Step S15, the controller 43 determines whether or not a lane that restarts transmission of any stream has been generated by transmission of any being restarted. For example, if transmission of any streams is not restarted, the processing of Steps S16 and S17 is skipped and the processing proceeds to Step S18.

In Step S18, the MSA generator 61 of the stream transmission processing unit 41 generates MSA for image data of the assigned stream in each lane and outputs it to the multiplexer 63.

In Step S19, the multiplexer 63 multiplexes, in each lane, each piece of image data of the assigned stream, which is supplied, with the NSA for each piece of image data to generate stream data and supplies it to the multiplexer 42.

In Step S20, the multiplexer 42 performs time division multiplexing on the plurality of pieces of stream data formed of the visible image data, which are supplied, in accordance with the format of the Virtual Channel.

In Step S21, the multiplexer 42 transmits multiplexed data generated by multiplexing to the receiver 22.

In Step S22, the transmitter 21 determines whether or not a next image signal is absent and an instruction to terminate the processing is performed.

If the instruction to terminate the processing is not performed, the processing returns to Step S11 and the subsequent processing is repeated. Then, if the instruction to terminate the processing is performed in Step S22, the processing ends.

On the other hand, in the receiver 22, in Step S51, the controller 83 receives the assignment information of Lane° to Lane3 supplied from the transmitter 21 in the processing of Step S11 via the AUX 84 and notifies each stream reception processing unit 82 of it.

In Step S52, the controller 83 determines whether or not the stream output from the division unit 81 in the previous processing contains a stop signal indicating the stop of transmission. In Step S52, for example, it is determined that it does not contain the stop signal indicating the stop of transmission in the previous processing, the processing of Step S53 is skipped and the processing proceeds to Step S54. Note that since the previous processing does not exist in first processing, it is considered that it does not contain the stop signal.

In Step S54, the controller 83 determines whether or not the stream output from the division unit 81 in the previous processing contains a signal indicating the restart of transmission. For example, if it is determined that it does not contain the signal indicating the restart of transmission, the processing of Step S55 is skipped and the processing proceeds to Step S56.

In Step S56, the division unit 81 of the receiver 22 receives the transmitted, multiplexed data.

In Step S57, the division unit 201 of the receiver 22 divides the received multiplexed data into the plurality of pieces of stream data formed of the visible image data in accordance with the format of the Virtual Channel and supplies each of them to the stream reception processing unit 82 and the controller 83.

In Step S58, the division unit 91 of the stream reception processing unit 82 divides the stream data formed of the visible image data into the MSA for the visible image and the visible image data and outputs the MSA for the visible image to the MSA reader 92 and the visible image data to the image generator 94.

In Step S59, the MSA reader 92 reads the MSA with respect to the stream assigned in each lane and supplies information on the read MSA to the image generator 94.

In Step S60, the image generator 94 reconfigures the visible image from the visible image data on the basis of the information on the MSA of the stream assigned in each lane and outputs it.

In Step S61, the receiver 22 determines whether or not next image data is absent and an instruction to terminate the processing is performed. If the instruction to terminate the processing is not performed, the processing returns to Step S51 and the subsequent processing is repeated. Then, if the instruction to terminate the processing is performed in Step S61, the processing ends.

In the above-mentioned processing, if the streams VC1 and VC2 are transmitted as in FIG. 5, the stream VC1 is transmitted through Lane0 and Lane1 and the stream VC2 is transmitted through Lane2 and Lane3.

Further, for example, if transferring of the stream VC2 is stopped, it is considered in Step S12 that there is a lane that should be stopped and the processing proceeds to Step S13.

In Step S13, the controller 43 controls the multiplexer 42 to output a stop signal indicating the stop of transmission of the stream as the multiplexed data, which includes information on a corresponding lane whose transmission is stopped as shown in the range Z1 in FIG. 6, for example.

Corresponding to this, in Step S52, if it contains the stop signal indicating the stop of transmission in the previous processing, the processing proceeds to Step S53.

In Step S53, the controller 83 notifies all the stream reception controllers 82 so as to stop the operation of the corresponding lane that is a target whose transmission is stopped, for stopping the operation.

After this series of processing, in Step S14, the controller 43 controls all the stream transmission processing units 41 to stop the output from the lanes allocated to the stream VC2. With this operation, as shown in the range surrounded with the dotted line in FIG. 5, the transmission in the stream VC2 in Lane2 and Lane 3 is stopped and enters the ALPM (Advanced Link Power Management) state.

In addition, for example, if the transferring of the stream VC2 is restarted, it is considered in Step S15 that there is a lane that should he restarted and the processing proceeds to Step S16.

In Step S16, the controller 43 performs control to multiplex and output a restart signal indicating the restart of transmission of the stream, which includes information on a corresponding lane whose transmission is restarted, for example, as shown in the range Z2 in FIG. 6 via the AUX 44.

Corresponding to this, in Step S54, it is determined that it contains the restart signal indicating the restart of transmission for example and the processing proceeds to Step S55.

In Step S55, the controller 83 notifies all the stream reception controllers 82 so as to start the operation of the corresponding lane that is a target whose transmission is restarted, for restarting the operation.

After this series of processing, in Step S17, the controller 43 controls the stream transmission processing unit 41 to successively output signals shown in the ranges Z3 and 24 of FIG. 6 and restart the output from Lane2 and Lane3 allocated to the stream VC2. With this operation, as shown in the section following the range surrounded with the dotted line in FIG. 5, transmission in the stream VC2 in Lane2 and Lane3 is restarted and the ALPM (Advanced Link Power Management) state is terminated.

In the above-mentioned processing, a stream is assigned for each Lane by making a plurality of streams formed of visible image data into a single piece of streaming data in a case where transmission is performed using the Virtual Channel. Therefore, even if transmission of any stream is stopped, it is possible to stop it on the Lane-by-Lane basis and to prevent unnecessary power consumption only for ensuring the bandwidth. Therefore, it becomes possible to realize power saving.

By the way, the above-mentioned series of processing may be executed by hardware or may be executed by software. If the series of processing is executed by software, programs that configure that software are installed, from the recording medium, in a computer incorporated in dedicated hardware or for example, a general-purpose personal computer capable of executing various functions by installing various programs.

FIG. 8 shows a configuration example of a general-purpose personal computer. This personal computer includes a built-in CPU (Central Processing Unit) 1001. An input/output interface 1005 is connected to the CPU 1001 via a bus 1004. A ROM (Read Only Memory) 1002 and a RAM (Random Access Memory) 1003 are connected to the bus 1004.

A communication unit 1009 is connected to the input/output interface 1005. The communication unit 1009 is constituted by an input unit 1006 constituted by input devices such as a keyboard and a mouse into which a user inputs operation commands, an output unit 1007 that outputs processing operation screens and images of processing results to a display device, a storage unit 1008 constituted by a hard disk drive that stores programs and various types of data and the like, a LAN (Local Area Network) adaptor, and the like. The communication unit 1009 executes communication processing via a network represented by the Internet. Further, a drive 1010 is connected thereto. The drive 1010 reads and writes data from/in the removable medium 1011 such as a magnetic disk (including flexible disk), an optical disc (including CD-ROM (Compact Disc-Read Only Memory) and DVD (Digital Versatile Disc)), a magneto-optical disk (including MD (Mini Disc)), and a semiconductor memory.

The CPU 1001 executes various types of processing in accordance with the programs stored in the ROM 1002 or programs read from a removable medium 1011 such as a magnetic disk, an optical disc, a magneto-optical disk, and a semiconductor memory, installed into the storage unit 1008, and loaded into the RAM 1003 from the storage unit 1008. Data and the like necessary for the CPU 1001 to execute various types of processing are further stored in the RAM 1003 if necessary.

In the thus configured computer, the CPU 1001 loads, for example, programs stored in the storage unit 1008 into the RAM 1003 via the input/output interface 1005 and the bus 1004 and executes them. In this manner, the above-mentioned series of processing is performed.

Programs executed by the computer (CPU 1001) can be, for example, recorded and provided in the removable medium 1011 that is a package medium. Further, the programs can be provided via a wired or wireless transmission medium such as a local area network, the Internet, and digital satellite broadcasting.

In the computer, the programs can be installed into the storage unit 1008 via the input/output interface 1005 by the removable medium 1011 being mounted on the drive 1010. Further, the programs can be received by the communication unit 1009 via the wired or wireless transmission medium and installed into the storage unit 1008. Otherwise, the programs can be installed into the ROM 1002 and the storage unit 1008 in advance.

Note that the programs executed by the computer may be programs are processed chronologically in the order described in the present specification or may be programs processed concurrently or at necessary timings, for example, upon calling.

Further, in the present specification, the system means a collection of a plurality of components (apparatuses, modules (parts), etc.) and it does not matter whether or not all the components are contained in an identical casing. Therefore, a plurality of apparatuses housed in separate casings and connected via a network and a single apparatus including a plurality of modules housed within a single casing are both systems.

Note that embodiments of the present technology are not limited to the above-mentioned embodiments and various modifications can be made without departing from the gist of the present technology.

For example, the present technology can take a cloud computing configuration in which a single function is shared and cooperatively processed by a plurality of apparatuses via a network.

Further, the respective steps described above with reference to the above-mentioned flowcharts can be shared and executed by a plurality of apparatuses rather than being executed by a single apparatus.

In addition, if a single step includes a plurality of processes, the plurality of processes of the single step can be shared and executed by a plurality of apparatuses rather than being executed by a single apparatus.

It should be noted that the present technology can also take the following configurations.

(1) A transmission apparatus that transmits visible image data formed of effective pixel data of an image pickup apparatus by using a format for transmitting to a display, the transmission apparatus including:
a transmitter that transmits a plurality of streams formed of the visible image data to respective stream sinks from respective stream sources through a plurality of lanes in a single transmission channel; and
a controller that assigns the plurality of streams to the plurality of lanes on a stream-by-stream basis, in which
the transmitter transmits the plurality of streams through the lanes assigned by the controller on the stream-by-stream basis.

(2) The transmission apparatus according to (1), in which
the format for transmitting to the display is a format defined by DisplayPort (trademark), and
the transmitter uses a Virtual Channel defined by the DisplayPort (trademark) to transmit the plurality of streams formed of the visible image data to the respective stream sinks from the respective stream sources through the plurality of lanes in the single transmission channel.

(3) The transmission apparatus according to (1), in which
if transmission of any stream of the plurality of streams is stopped, the controller outputs, via the transmission channel, a stop signal for notifying that transmission through a corresponding lane is stopped.

(4) The transmission apparatus according to (3), in which
the stop signal is a signal in starting an ALPM (Advanced. Link Power Management) state defined by DisplayPort (trademark).

(5) The transmission apparatus according to (1), further including
an auxiliary communication unit different from the transmission channel that communicates with a reception apparatus that receives the plurality of streams, in which
if transmission of any stream of the plurality of streams is restarted, the controller notifies the reception apparatus of a restart signal via the auxiliary communication unit, the restart signal indicating that transmission through a corresponding lane is restarted.

(6) The transmission apparatus according to (5), in which
the restart signal is a signal in terminating an ALP (Advanced Link Power Management) state defined by DisplayPort (trademark).

(7) The transmission apparatus according to (1), further including
an auxiliary communication unit different from the transmission channel that communicates with a reception apparatus that receives the plurality of streams, in which
the controller uses the auxiliary communication unit to notify a reception apparatus that receives the plurality of streams of information indicating that the plurality of streams are assigned to the plurality of lanes on the stream-by-stream basis.

(8) A transmission method for a transmission apparatus that transmits visible image data formed of effective pixel data of an image pickup apparatus by using a format for transmitting to a display, the transmission method including:
a transmission step of transmitting a plurality of streams formed of the visible image data to respective stream sinks from respective stream sources through a plurality of lanes in a single transmission channel; and
a control step of assigning the plurality of streams to the plurality of lanes on a stream-by-stream basis, in which
processing of the transmission step transmits the plurality of streams through the lanes assigned by processing of the control step on the stream-by-stream basis.

(9) A program that causes a computer that controls a transmission apparatus that transmits visible image data formed of effective pixel data of an image pickup apparatus by using a format for transmitting to a display to execute processing including:
a transmission step of transmitting a plurality of streams formed of the visible image data to respective stream sinks from respective stream sources through a plurality of lanes in a single transmission channel; and
a control step of assigning the plurality of streams to the plurality of lanes on a stream-by-stream basis, in which
the processing of the transmission step transmits the plurality of streams through the lanes assigned by the processing of the control step on the stream-by-stream basis.

(10) A reception apparatus that receives visible image data formed of effective pixel data of an image pickup apparatus by using a format for transmitting to a display, the reception apparatus including:
a receiver that receives a plurality of streams formed of the visible image data, which are transmitted to the respective stream sinks from the respective stream sources, through the plurality of lanes in the single transmission channel; and
a controller that assigns the plurality of streams to the plurality of lanes on a stream-by-stream basis, in which
the receiver receives the plurality of streams in the lanes assigned by the controller on the stream-by-stream basis.

(11) The reception apparatus according to (10), in which
the format for transmitting to the display is a format defined by DisplayPort (trademark), and
the receiver uses a Virtual Channel defined by the DisplayPort (trademark) to receive the plurality of streams formed of the visible image data, which are transmitted to the respective stream sinks from the respective stream sources.

(12) The reception apparatus according to (10), further including
an auxiliary communication unit different from the transmission channel that communicates with a transmission apparatus that transmits the plurality of streams, in which
the controller uses the auxiliary communication unit to receive information indicating that the plurality of streams are assigned to the plurality of lanes on the stream-by-stream basis from the transmission apparatus that transmits the plurality of streams and to assign, on the basis of the received information, the plurality of streams to the plurality of lanes on the stream-by-stream basis.

(13) A reception method for a reception apparatus that receives visible image data formed of effective pixel data of an image pickup apparatus by using a format for transmitting to a display, the reception method including:
a reception step of receiving a plurality of streams formed of the visible image data to respective stream sinks from respective stream sources through a plurality of lanes in a single transmission channel; and
a control step of assigning the plurality of streams to the plurality of lanes on a stream-by-stream basis, in which
processing of the reception step receives the plurality of streams in the lanes assigned by processing of the control step on the stream-by-stream basis.

(14) A program that causes a computer that controls a reception apparatus that receives visible image data formed of effective pixel data of an image pickup apparatus by using a format for transmitting to a display to execute processing including:
a reception step of receiving a plurality of streams formed of the visible image data to respective stream sinks from respective stream sources through a plurality of lanes in a single transmission channel; and
a control step of assigning the plurality of streams to the plurality of lanes on a stream-by-stream basis, in which
the processing of the reception step receives the plurality of streams in the lanes assigned by the processing of the control step on the stream-by-stream basis.

(15) A transmission system, including:
a transmission apparatus that transmits visible image data formed of effective pixel data of an image pickup apparatus by using a format for transmitting to a display; and
a reception apparatus, in which
the transmission apparatus includes
   a transmitter that transmits a plurality of streams formed of the visible image data to respective stream sinks from respective stream sources through a plurality of lanes in a single transmission channel, and
   a first controller that assigns the plurality of streams to the plurality of lanes on a stream-by-stream basis,
the transmitter transmits the plurality of streams through the lanes assigned by the first controller on the stream-by-stream basis,
the reception apparatus includes
   a receiver that receives a plurality of streams formed of the visible image data, which are transmitted to the respective stream sinks from the respective stream sources, through the plurality of lanes in the single transmission channel; and
   a second controller that assigns the plurality of streams to the plurality of lanes on the stream-by-stream basis, and
the receiver receives the plurality of streams in the lanes assigned by the second controller on the stream-by-stream basis.

### REFERENCE SIGNS LIST

21 transmitter, 22 receiver, 41, 41-1 to 41-n stream transmission processing unit, 42 multiplexer, as controller, 44 AUX (auxiliary communication unit), 61 MSA generator, 62 SDP generator, 63 multiplexer, 81 division unit, 82, 82-1 to 82-n stream reception processing unit, 91 division unit, 92 MSA reader, 93 SDP reader, 94 image generator

1. A transmission apparatus that transmits visible image data formed of effective pixel data of an image pickup apparatus by using a format for transmitting to a display, the transmission apparatus comprising:
a transmitter that transmits a plurality of streams formed of the visible image data to respective stream sinks from respective stream sources through a plurality of lanes in a single transmission channel; and
a controller that assigns the plurality of streams to the plurality of lanes on a stream-by-stream basis, wherein
the transmitter transmits the plurality of streams through the lanes assigned by the controller on the stream-by-stream basis.

2. The transmission apparatus according to claim 1, wherein
the format for transmitting to the display is a format defined by DisplayPort (trademark), and
the transmitter uses a Virtual Channel defined by the DisplayPort (trademark) to transmit the plurality of streams formed of the visible image data to the respective stream sinks from the respective stream sources through the plurality of lanes in the single transmission channel.

3. The transmission apparatus according to claim 1, wherein
if transmission of any stream of the plurality of streams is stopped, the controller outputs, via the transmission channel, a stop signal for notifying that transmission through a corresponding lane is stopped.

4. The transmission apparatus according to claim 3, wherein
the stop signal is a signal in starting an ALPM (Advanced. Link Power Management) state defined by DisplayPort (trademark).

5. The transmission apparatus according to claim 1, further comprising
an auxiliary communication unit different from the transmission channel that communicates with a reception apparatus that receives the plurality of streams, wherein
if transmission of any stream of the plurality of streams is restarted, the controller notifies the reception apparatus of a restart signal via the auxiliary communication unit, the restart signal indicating that transmission through a corresponding lane is restarted.

6. The transmission apparatus according to claim 5, wherein
the restart signal is a signal in terminating an ALPM (Advanced Link Power Management) state defined by DisplayPort (trademark).

7. The transmission apparatus according to claim 1, further comprising
an auxiliary communication unit different from the transmission channel that communicates with a reception apparatus that receives the plurality of streams, wherein
the controller uses the auxiliary communication unit to notify a reception apparatus that receives the plurality of streams of information indicating that the plurality of streams are assigned to the plurality of lanes on the stream-by-stream basis.

8. A transmission method for a transmission apparatus that transmits visible image data formed of effective pixel data of an image pickup apparatus by using a format for transmitting to a display, the transmission method comprising:
a transmission step of transmitting a plurality of streams formed of the visible image data to respective stream sinks from respective stream sources through a plurality of lanes in a single transmission channel; and
a control step of assigning the plurality of streams to the plurality of lanes on a stream-by-stream basis, wherein
processing of the transmission step transmits the plurality of streams through the lanes assigned by processing of the control step on the stream-by-stream basis.

9. A program that causes a computer that controls a transmission apparatus that transmits visible image data formed of effective pixel data of an image pickup apparatus by using a format for transmitting to a display to execute processing comprising:
a transmission step of transmitting a plurality of streams formed of the visible image data to respective stream sinks from respective stream sources through a plurality of lanes in a single transmission channel; and
a control step of assigning the plurality of streams to the plurality of lanes on a stream-by-stream basis, wherein
the processing of the transmission step transmits the plurality of streams through the lanes assigned by the processing of the control step on the stream-by-stream basis.

10. A reception apparatus that receives visible image data formed of effective pixel data of an image pickup apparatus by using a format for transmitting to a display, the reception apparatus comprising:
a receiver that receives a plurality of streams formed of the visible image data, which are transmitted to the respective stream sinks from the respective stream sources, through the plurality of lanes in the single transmission channel; and
a controller that assigns the plurality of streams to the plurality of lanes on a stream-by-stream basis, wherein
the receiver receives the plurality of streams in the lanes assigned by the controller on the stream-by-stream basis.

11. The reception apparatus according to claim 10, wherein
the format for transmitting to the display is a format defined by DisplayPort (trademark), and
the receiver uses a Virtual Channel defined by the DisplayPort (trademark) to receive the plurality of streams formed of the visible image data to the respective stream sinks from the respective stream sources through the plurality of lanes in the single transmission channel.

12. The reception apparatus according to claim 10, further comprising
an auxiliary communication unit different from the transmission channel that communicates with a transmission apparatus that transmits the plurality of streams, wherein
the controller uses the auxiliary communication unit to receive information indicating that the plurality of streams are assigned to the plurality of lanes on the stream-by-stream basis from the transmission apparatus that transmits the plurality of streams and to assign, on the basis of the received information, the plurality of streams to the plurality of lanes on the stream-by-stream basis.

13. A reception method for a reception apparatus that receives visible image data formed of effective pixel data of an image pickup apparatus by using a format for transmitting to a display, the reception method comprising:
a reception step of receiving a plurality of streams formed of the visible image data, which are transmitted to respective stream sinks from respective stream sources through a plurality of lanes in a single transmission channel; and
a control step of assigning the plurality of streams to the plurality of lanes on a stream-by-stream basis, wherein
processing of the reception step receives the plurality of streams in the lanes assigned by processing of the control step on the stream-by-stream basis.

14. A program that causes a computer that controls a reception apparatus that receives visible image data formed of effective pixel data of an image pickup apparatus by using a format for transmitting to a display to execute processing comprising:
a reception step of receiving a plurality of streams formed of the visible image data, which are transmitted to respective stream sinks from respective stream sources through a plurality of lanes in a single transmission channel; and
a control step of assigning the plurality of streams to the plurality of lanes on a stream-by-stream basis, wherein
the processing of the reception step receives the plurality of streams in the lanes assigned by the processing of the control step on the stream-by-stream basis.

15. A transmission system, comprising:
a transmission apparatus that transmits visible image data formed of effective pixel data of an image pickup apparatus by using a format for transmitting to a display; and
a reception apparatus, wherein
the transmission apparatus includes
a transmitter that transmits a plurality of streams formed of the visible image data to respective stream sinks from respective stream sources through a plurality of lanes in a single transmission channel, and
a first controller that assigns the plurality of streams to the plurality of lanes on a stream-by-stream basis,
the transmitter transmits the plurality of streams through the lanes assigned by the first controller on the stream-by-stream basis,
the reception apparatus includes
a receiver that receives a plurality of streams formed of the visible image data, which are transmitted to the respective stream sinks from the respective stream sources, through the plurality of lanes in the single transmission channel; and
a second controller that assigns the plurality of streams to the plurality of lanes on the stream-by-stream basis, and
the receiver receives the plurality of streams in the lanes assigned by the second controller on the stream-by-stream basis.
